(19) United States
(12) Patent Application Publication
(10) Pub. No.: US 2015/0058073 A1
(43) Pub. Date: Feb. 26, 2015

(54) CROWDSOURCED INNOVATION EXCHANGE

(71) Applicant: Dmitrii Gorbunov, Tolyatti (RU)

(72) Inventor: Dmitrii Gorbunov, Tolyatti (RU)

(21) Appl. No.: 13/970,843

(22) Filed: Aug. 20, 2013

(51) Int. Cl. G06Q 30/02; G06Q 50/18

(52) U.S. Cl. CPC G06Q 30/0201; G06Q 50/184
USPC 705/7.29

(57) ABSTRACT

A method for crowdsourcing, funding, and development of innovative projects. The method includes posting proposed projects on an online database, allowing experts and investors access to project files. Experts may only write positive reviews of the projects, thus supporting those projects which they believe should be successful and beneficial. By creating a professional network where experts receive commission only after a project is funded by investors, experts become active, enthused, and much more engaged in the review process as well as the development of the projects they choose to endorse. This method solves problems such as the finite number of passive expert reviewers, high examination fees, and weak competition rates.

### FIELD OF THE INVENTION

This invention relates generally to electronic methods employing crowdsourcing for review and funding of innovative projects developing new technology and ideas.

### BACKGROUND OF THE INVENTION

The prior art in the field of the present invention discloses several crowdsourcing methods, including internal reward and user rating systems.

US 2013/0029769 A1 (“Aggregate Crowdsourcing Platforms”) discloses a method of combining several crowdsourcing platforms. Under this prior an system, a given user creates and presents a contest to a plurality of communities and users, allowing for submissions by other users until the contest-creator determines the winning submission/solution and delivers a prize to the winning user.

US 2013/0060715 A1 (“Intellectual property commercialization supporting system capable of diversifying investment risk based on social network”) discloses a system for supporting IP commercialization. In that system, a project is presented on a social network, where business experts, technology providers, and perhaps capital investors can join the discussion and offer funding to implement the commercialization of the targeted technology.

US 2012/0284090 A1 (“System and method for accumulation and verification of trust for participating users in a crowd sourcing activity”) discloses a computer network system for verification of crowdsourcing activity for accuracy and granting incentives to participating users based on the accuracy of submitted information and/or crowdsourcing activities. This system improves the quality of crowdsourcing activity by creating publicly visible trust or quality scores for each participating user.

US 2013/0096968 A1 (“Performance data in a worker profile aggregated by a job distribution platform for workers that perform crowd sourced tasks”) similarly discloses a method for generating profile data of a given user on a crowdsourcing platform. By tracking the history of previous job including the task of interest, individual user/employee job data can be retrieved. New jobs can be assigned to individuals based on the performance data.

US 2013/0006736 A1 (“Providing rewards to users based on their levels of influence over other users”) discloses a method of a crowdsourcing platform that provides rewards to individual users who have the greatest influence over other users on the platform. The success of a user is determined by the performance of location-based actions of other users.

US 2010/0005020 A1 (“Funding of projects”) discloses a computer-based method for funding of a project through selling of interests in the project to investors, allowing investors to trade the interests (as securities) in order to reach a predetermined amount of funding. This method also optionally includes enablement of experts to receive information online and provide reports about the project for use by investors.

US20080077461 A1 (“Methods and system for ranking in expert referral”) discloses a method of rating an individual expert's value to a community of potential clients. The rating is based on the extent to which that individual has been engaged in a similar task repeatedly.

### SUMMARY OF THE INVENTION

An electronic online method for providing expert review and funding of individually proposed projects employing new technology and/or ideas. The method is comprised of allowing project initiators/proponents to post projects on an online platform or database, allowing industry experts to review and endorse specific projects, and simultaneously giving investors the opportunity to fund those projects which are highly endorsed by expert review. This provides not only a guide for investors, but also a free examination—perhaps several free examinations—for project proponents due to an incentive and commission for experts, especially those experts who perform on a higher level than others. The expert commissions are earned only when an endorsed project is funded, and the amount of commission depends on the timeliness of review as well as the rating given to the expert based on overall performance on the online platform.

### BRIEF DESCRIPTION OF THE DRAWINGS

FIG. 1 shows how the different users of today's best method interact.

FIG. 2 shows how the different users of the claimed method of this invention interact.

FIG. 3 shows how each individual expert receives his/her own platform “review success rating”.

FIG. 4 shows the details of determining each expert reviewer's commission once a project is funded.

### DETAILED DESCRIPTION OF THE PREFERRED EMBODIMENT

Today, if the proponent of an idea wants to invest, he or she is forced to order a costly expert, of which there are very few, for a review of the idea or project. The situation is the same for investors; if they want to fund a project, they also must pay for expert examination or review in order to make an informed decision whether or not to follow through with the project. This type of method creates a passive role for each expert reviewer associated with and employed by any such platform. Each expert only attempts to review as many projects as possible without gaining a true interest in any individual project's actual development.

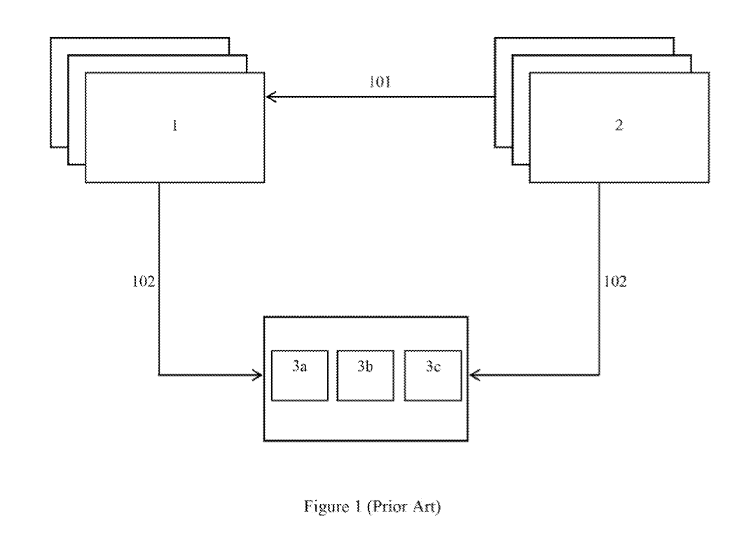

FIG. 1 depicts today's best method for innovation based on expert examination. There is exists a plurality of projects proposed by project initiators (i.e. inventors, scientists, innovators, etc.) 1 who must pay for expensive examination 102 by one of a very select and small group of passive and disinterested experts 3. A plurality of investors 2 who hope to eventually fund some projects 101 must also pay for costly examination 102 of projects that they believe might be successful.

The weaknesses and problems of today's method include the following: (1) a limited number of experts, (2) high cost of examination/review, (3) losses resulting from negative examinations/reviews, (4) lack of interested experts in the development of reviewed projects, (5) limited application/use of examinations/reviews (they are used only by the person who orders the examination/review), (6) lack of competition and/or investors, (7) experts bear the risk, or profit, based solely on the amount of examinations/reviews that are ordered.

The present invention transforms the type of role of an expert reviewer from passive and disinterested to active and engaged. This means that experts can no longer simply profit based solely on the amount of reviews they perform, without regard to whether the review is positive or negative and without an interest in the development of any given project. Prior methods have lacked incentives for experts. The claimed method creates greater incentives for expert review by basing the experts' earnings or profit on the amount of beneficial and positive reviews performed, rather than just the number of overall reviews (regardless of their benefit). By forcing experts to choose which projects to review, rather than allowing them to take every review ordered, experts become personally interested in those projects which they endorse.

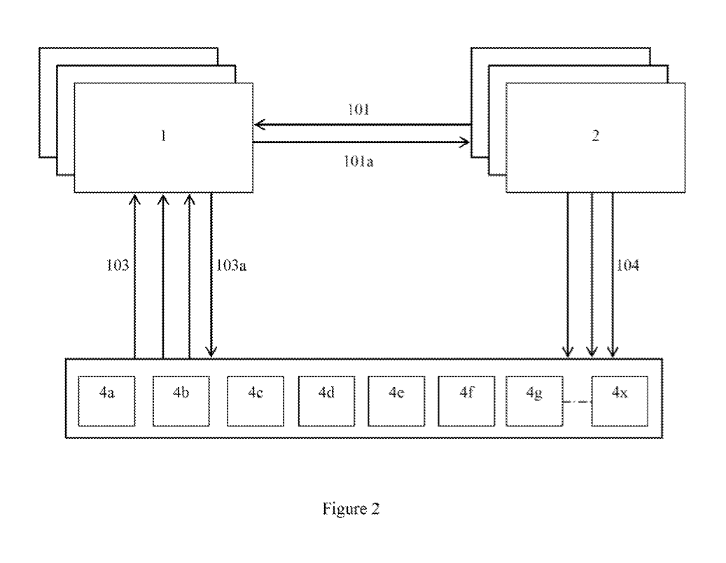

A multilingual electronic platform forms the basis of an exchange; the elements of the exchange are depicted in FIG. 2. Within this exchange, an array of projects files 1 employing new technologies and ideas are proposed to experts 103a who may then upload positive expert reports 103 to those project files which they endorse or support. At the same time, the project files 1 are proposed to investors 101a for their funding 101. Several types of individuals make up the different groups of user/members of this electronic platform or exchange: initiators (a.k.a. proponents, sellers), investors (a.k.a. buyers) 2, and experts (a.k.a. reviewers) 4a-4x. Initiators are those individuals with the ideas for projects they present the idea and create the project file 1 on the exchange, making it available for potential uploading of positive reports 103 and funding 101. Experts 4 are provided the opportunity to perform reviews and upload positive reports (in the form of essays, articles, opinions, etc.) 103 of the projects proposed by initiators. Experts are only authorized to provide positive, or supporting, reviews/conclusions/reports; no negative reviews are supported by the claimed method (thus, if an expert does not support a project, i.e. wants to write a negative review, there is no review given at all). Investors then provide funding 101 to those projects which they believe will be successful, based at least in part on the expert reviews. As more positive reviews are associated with a given project file 1, the potential risk and cost of that project decreases, making that project more attractive to investors 2. And once a project is funded, a part of the investment money is allotted 104 to the experts who reviewed the same project, distributed according to the method described below.

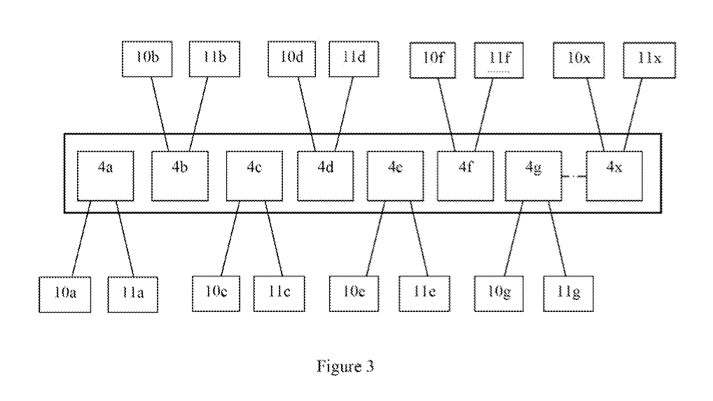

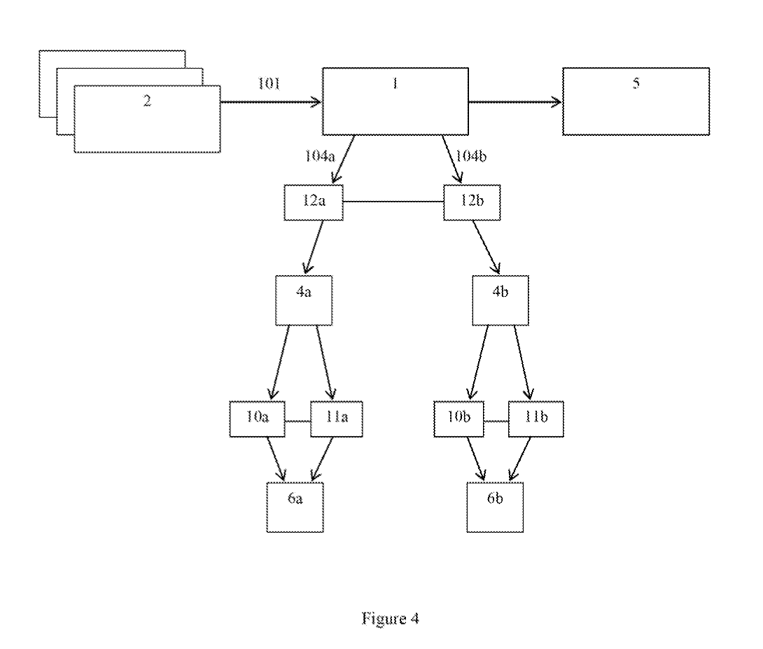

Once a listed project receives several positive examinations and becomes more attractive to investors, investors decide to fund the project. Access to the projects, however, is provided simultaneously to both experts (for review) and investors (for funding). Thus, in theory, an investor could choose to fund a project before any reviews are published fur that project. In this way, each project file can be funded at any given point, with or without a certain threshold number of positive reviews. Although funding will likely not occur without at least one positive expert review, a project on the currently claimed platform, in theory, could be funded without any positive reviews from experts. Once a given project is funded, every expert who provided a positive review of that project prior to the funding transaction receives a commission based on two ratings provided by the platform (See FIGS. 3-4). The first expert commission rating is based on the expert's cumulative rating based on overall prior performance. This rating, unique to each individual expert, is determined by the ratio, N, calculated by the formula N=K/S, where K represents the number of positively reviewed projects actually funded 10 and S represents the overall or total number of projects positively reviewed by that expert 11 (“review success rating,” or “R”). The second expert commission rating 12 is based on the timeliness “priority rating,” or “T”) of the expert's review of the specific project currently gaining funding. This timeliness rating, T, is calculated based on the position, or timing, of one expert's review in relation to all other experts' reviews for one proposed project or idea. For example, if twenty (20) experts publish reviews of a project, the first expert to publish a review receives the highest priority rating (e.g., T=20), the second expert to publish a review receives the second highest priority rating (e.g., T=19), the third expert to publish a review receives the third highest priority rating (e.g., T=18), and so on (until the last expert to publish a review for the project, who, e.g., receives a priority rating of T=1). A higher priority rating corresponds to a greater expert's commission. Thus, once funded, an earlier in time expert review 12a of the funded project receives a greater reward than a later expert review 12b of the same project. This creates an additional incentive for experts to publish a positive review of a given project as early as possible (and before all other experts publish their respective reviews) once the project is listed on the platform.

FIG. 4 further illustrates the method for determining the expert's commission once a project is funded. Once an investor or group of investors 2 makes a necessary transaction to fund a project 1, most of the funding goes towards development of the project 5. However, a part of the investor's money goes 104a, 104b towards the commission of each expert who reviewed the specific project funded. In the scenario depicted in FIG. 4, two experts 4a, 4b reviewed the funded project at hand 1. Expert 4a performed a review earlier in time than expert 4b, and thus the expert earlier in time 4a receives a higher priority rating 12a over an expert who performed a review of the same project later in time 12b. The priority rating 12a, 12b sets the first criteria for determining the expert's commission (i.e. the higher the priority rating, the higher the commission). The second criteria is set by the expert's review success rating (N=K/S), determined by the ratio of the number of positively reviewed projects actually funded (K) 10a, 10b to the total number of projects reviewed and endorsed by the expert regardless of selection for funding (S) 11a, 11b (i.e. the higher the review success rating, the higher the commission or hourly rate). Taking both criteria into account, the funds allotted for expert commission are distributed accordingly among each expert reviewer, resulting in a commission (or payout) 6a, 6b for each expert. While FIG. 4 illustrates the commission payout scheme with two experts, the same process is applicable to any number of experts that publish and upload positive reports for a given project once it is funded. Furthermore, each individual expert's review success rating is coupled to their profile on the platform, giving all other users a relative idea of that expert's qualities, such as platform activity, competence, and reliability.

The following is an example of the life cycle of one specific proposed project file: (1) A project file is initiated by a proponent of an idea creating a project file, together with a project certificate which places the project within a required classification based on project characteristics; (2) Guest members on the portal can evaluate, or comment on, projects arbitrarily (note: guests do not have the same power/role as experts; this step occurs for less-than-expert support and statistical analysis potentially beneficial to investor decision-making); (3) Experts evaluate the project file, determining whether the project is support-worthy; (4) Experts upload positive reports for the project if and only if they believe that the project has potential for success; (5) A feasibility study is compiled as more experts and guest users evaluate the project file (the study is compiled based on public hearings, expert evaluations, consumer volume statistics, graphics, price, etc.); (6) The project file receives a rating based on the feasibility study (this rating changes continuously as more platform users visit the project file; (7) An investor (or group of investors) decide to fund the project file based on the file's high rating; (8) All experts who published and uploaded a positive report prior to the decision to fund receive a commission based on their review success rating and priority rating; (9) The protect file remains on the platform for continued monitoring (this is beneficial for determination of the accuracy of platform ratings, and for additional funding opportunities).

Within the platform, experts must choose which projects to review (and which projects to avoid reviewing). Because there are no negative reviews, an expert has the opportunity to profit and build his/her rating based only on the projects that the expert believes will truly be funded. This provides a solution to the problem of paying for costly expert reviews of every project, whether or not it is eventually accepted and funded. In today's innovative process, experts tend to write both positive and negative reviews on as many projects as possible, hoping that at least some of the projects reviewed gain funding. The expert on prior platforms has nearly nothing to lose, for the costly review is paid for prior to the decision to fund by investors. So long as some reviewed projects are funded, the expert's reputation continues to strengthen. The rating and incentive system of the present invention eliminates the problem of the disinterested expert. In the claimed method, the reputation of an expert, the expert qualification, and the expert's hourly rate are determined based on the number of projects reviewed and funded compared with the number of projects reviewed and not funded. For example, an expert who writes 10 reviews, 9 of which are eventually funded, receives a higher qualification and hourly rate than another expert who writes 30 reviews, only 10 of which are eventually funded.

Within the claimed method, initiators and investors are registered anonymously with identification numbers, and without names or titles, to protect their identity. Experts, on the other hand, must register with their full names, regalia, and scientific works. Thus, while the experts can receive commission for their beneficial reviews, they must also bear the reputational risks associated with their cooperation.

The strengths and benefits of the claimed invention include: (1) a global market, (2) an unlimited amount of experts from different countries (thus creating a professional expert community with several branches), (3) an unlimited number of investors, (4) an unlimited number of initiators, (5) an active interest of experts in the development of indorsed projects, (6) absence of negative reviews/assessments, (7) no cost for expert review/examination, (8) extended use of expert examinations (potential future citation in scientific papers in the case of a successful project), (9) increased competition between investors (on an online electronic platform, an investor has only a limited amount of time before others investors decide to fund a project), and (10) experts are given the opportunity to build their reputation, using the platform to promote their vision of the development of their respective industries.

The description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

What is claimed is:

1. A method for project finding based on crowdsourcing expertise, comprising:
aggregating a plurality of proponents' project files on an electronic platform;
providing access to said plurality of proponents' project files to experts, the experts selecting only projects which they recommend for funding and publishing only positive reports for selected projects;
uploading the project files with corresponding expert reports;
simultaneously providing access to investors via said platform to said project files, wherein the investors select individual projects for funding based on the positive reports;
wherein said experts receive a commission for publishing the positive report for the project selected for funding, the report submitted prior to selection for funding; and
wherein the commission of an individual expert is determined relative to a rating of this expert, which is based on the ratio N (review success rating), wherein N=K/S, wherein K represents the number of reports written by this expert on projects actually funded and S represents the number of total reports written on said platform by this expert, S includes both projects selected for funding and not selected for funding.

2. The method of claim 1, herein the commission of a given expert is further determined relative to a platform priority rating, wherein said priority rating is determined based on the order in which said expert publishes his positive report relative to all other positive reports for the same project file until said file is selected for funding, wherein an expert who published a report earlier in time receives a higher rating than an expert who published a report later in time, thus placing each reporting expert in a ranking order of first expert to publish to last expert to publish, and highest priority rating resulting in a higher commission, and lowest priority rating resulting in a lower commission.

3. The method of claim 1, wherein the positive expert report is in the form of an essay, opinion, letter, article, comment, or acknowledgement.

4. The method of claim 1, wherein the investors are anonymous.

5. The method of claim 1, wherein the proponents are anonymous.

6. The method of claim 1, wherein the experts are not anonymous and bear a reputational risk.
